(19) United States
(12) Patent Application Publication
(10) Pub. No.: US 2022/0376345 A1
(43) Pub. Date: Nov. 24, 2022

(54) BATTERY HOUSING FOR COUPLING TO MULTIPLE DIFFERENT BATTERY TYPES

(71) Applicant: Southwest Research Institute, San Antonio, TX (US)

(72) Inventors: Nicholas A. HERRERA, San Antonio, TX (US); Gabriel Steven SOLIS, Castroville, TX (US)

(21) Appl. No.: 17/303,099

(22) Filed: May 20, 2021

(51) Int. Cl. H01M 50/267; H01M 50/213; H01M 50/244; H01M 50/296

(52) U.S. Cl. CPC H01M 50/267; H01M 50/213; H01M 50/244; H01M 50/296

(57) ABSTRACT

A battery housing is disclosed that includes a multi-battery configuration based on a common battery cradle that can support two different battery types such that batteries of a first and a second type may be utilized to supply power to a device in an alternative/interchangeable fashion. Therefore, a user/operator of a device may then select batteries of the first type, or the second type, such that the battery housing includes only batteries of the first or second type during operation of the device, but not both.

### TECHNICAL FIELD

This specification relates generally to battery housings/enclosures, and in particular, to a battery housing with a common battery cradle that supports multiple battery types that can be interchangeably coupled to the common battery cradle based on a user selection.

### BACKGROUND INFORMATION

Designers of battery-operated electronics often must weigh the tradeoffs between battery types when selecting which battery type and battery size to use in a given device. Some factors which are considered during battery selection include energy density, voltage and current requirements, volume/footprint requirements, cost, and commercial availability. Alkaline batteries such as AA batteries, e.g., R6 batteries as defined by IEC 60086, are one of the most readily available batteries around the world and are relatively low cost compared to lithium chemistry batteries. However, AA batteries have a relatively low energy density relative to lithium batteries, such as a CR123A batteries. However, CR123A batteries are generally more difficult to source and are more expensive than AA batteries.

In addition to the AA and CR123A example, the same tradeoffs impact other battery options as well, such as for nine-volt (size PP3) batteries. Although nine-volt (9V) batteries and AA batteries are now manufactured in primary lithium and rechargeable versions, these options are not commonly available and have a higher cost relative to their non-lithium counterparts. The widest available 9V and AA batteries remains the alkaline version.

Often the final battery choice for a given design is based primarily on weighing of such tradeoffs. There exists a need to allow for battery designers to utilize standard, commercially-available batteries to select batteries based on desired features rather than tradeoffs.

### BRIEF DESCRIPTION OF THE DRAWINGS

These and other features will be better understood by reading the following detailed description, taken together with the drawings wherein:

FIG. 1 shows a perspective view of an example battery housing consistent with aspects of the present disclosure.

FIG. 2 shows the example battery housing of FIG. 1 partially exploded in accordance with aspects of the present disclosure.

FIG. 3 shows an example housing portion of the battery housing of FIG. 1 in isolation, in accordance with aspects of the present disclosure.

FIG. 4 shows another perspective view of the example battery housing of FIG. 1 in accordance with aspects of the present disclosure.

FIG. 5 shows a top view of an example housing portion of the battery housing of FIG. 1 in isolation, in accordance with aspects of the present disclosure.

FIG. 6 shows another example housing portion of a battery housing consistent with the present disclosure with batteries of a first battery type disposed therein.

FIG. 7 shows the housing portion of FIG. 6 with batteries of a second battery type disposed therein.

FIG. 8 shows a schematic view of a battery housing that supports interchangeable coupling of batteries of two different battery types in accordance with aspects of the present disclosure.

FIG. 9 shows a schematic view of a battery housing that supports interchangeable coupling of batteries of two different battery types in accordance with aspects of the present disclosure.

### DETAILED DESCRIPTION

For battery-operated devices, there is generally only one battery type used to supply power. Thus, battery housings/compartments for a device are generally configured to hold one type of battery, and when increased capacity/voltage is necessary, battery housings can include space to allow for multiple batteries of the same type to electrically couple together. This results in a device owner/operator having to source one type of battery compatible with the device, even when a given battery type is difficult to source, cost-prohibitive, and/or does not provide desired electrical characteristics relative to the application.

In view of the foregoing, aspects of the present disclosure recognize that providing a battery housing that can support batteries of two different types in an alternative/interchangeable fashion, and preferably two different standardized battery types such as AAs, CR123s (e.g., CR123, CR123A) and 9V battery package types, allows a user to select a battery type best suited to a given scenario/application rather than requiring the user to source a single battery type for operation of a device. Different battery types provide advantages not necessarily available in other battery types such as electrical characteristics, commercial availability, and cost.

For example, some battery chemistries are better suited for small current draws, while others perform optimally at higher current draws. Thus, for equipment/devices that can operate in a first mode that includes relatively small current draw, e.g., 1-10 milliamps (mA), a first battery type selected for the device is preferably well suited for such small current draws. On the other hand, the equipment can include a second mode that has a relatively high current draw, e.g., greater than 100 mA, and a second battery type for the device to handle such a mode is preferably well suited for larger current draws relative to the first battery type. A battery housing consistent with the present disclosure allows a user to interchangeably switch between batteries of the first and second type depending on the desired mode of operation rather than requiring a single battery type to support all modes.

In addition, it is well known that battery performance and/or lifespan varies with environmental characteristics such as ambient temperature, and it may be desirable to provide devices with multiple battery options that enable operation in multiple distinct operating environments, e.g., an environment below 30 degrees Celsius and an environment above 50 degree Celsius. Thus, allowing devices to operate with two different alternative battery types is desirable in a wide range of scenarios where no single battery type can necessarily ensure nominal/desired performance.

Thus, in accordance with aspects of the present disclosure, a battery housing is disclosed that includes a multi-battery configuration based on a common battery cradle that can support two different battery types such that batteries of a first and a second type may be utilized to supply power to a device in an alternative/interchangeable fashion. Therefore, a user/operator of a device may then select batteries of the first type, or the second type, such that the battery housing includes only batteries of the first or second type during operation of the device, but not both.

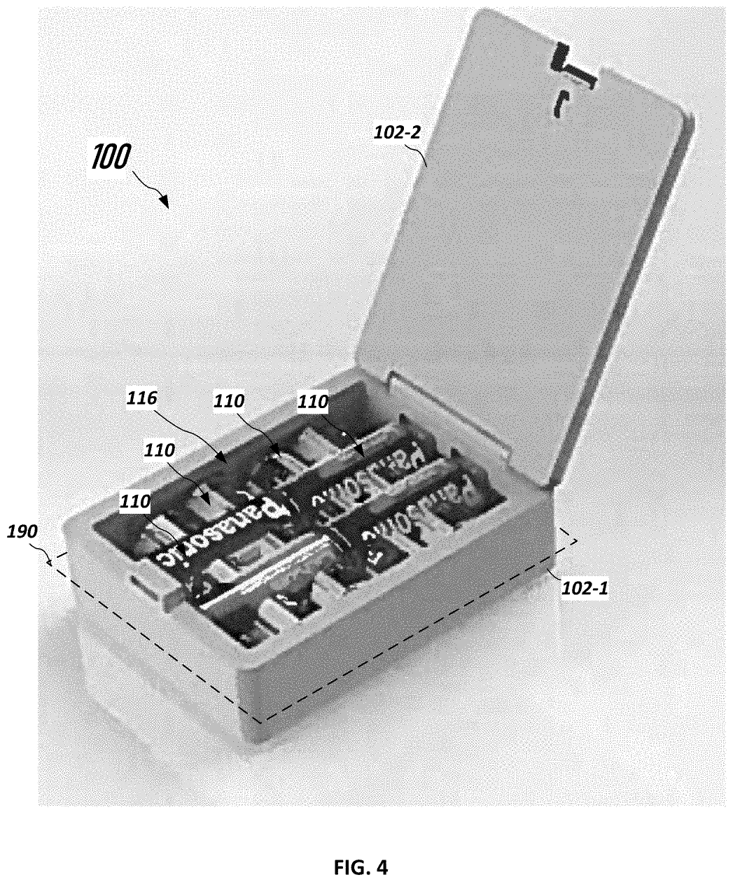

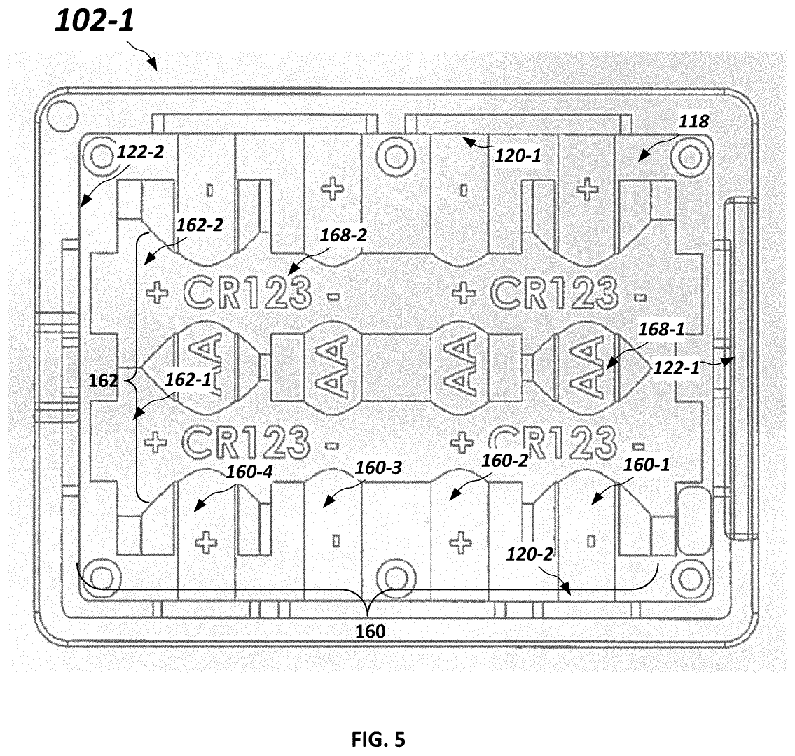

Preferably, the common battery cradle within the battery housing physically and electrically couples to batteries of either the first or second battery types depending on a desired configuration. For example, and as discussed further below, the common battery cradle of the battery housing is preferably configured to provide battery slots/grooves for one or more batteries of a first type that intersects with battery/slots grooves for one or more batteries of a second type (See e.g., FIG. 5). Accordingly, coupling of a battery of the first type to the common battery cradle obstructs/prevents coupling of a battery of the second type, and vice-versa. Therefore, the common battery cradle preferably includes an overlapping/intersecting configuration such that in an imaginary scenario where batteries of both the first and second type are disposed thereon, a common horizontal plane extends through each of the batteries of the first and second type (See e.g., FIG. 4). More preferably, the common horizontal plane extends through the entire overall length of the first and second batteries such that the common horizontal plane extends through each battery end-to-end. Advantageously, the common battery cradle may therefore be configured to couple to two different battery types by providing battery slots/grooves in a co-located manner that avoids the necessity of dedicating separate space for batteries of each type.

Preferably, a battery housing consistent with the present disclosure includes power circuitry configured to ensure that output voltage is constant regardless of whether the device is operating via batteries of the first or second type, as is discussed in further detail below. The constant output voltage is preferably provided based on how batteries of the first and second type are electrically coupled to each other (e.g., electrically in series or parallel). However, the battery housing may further include additional power circuitry to step up/down output power or otherwise maintain a nominal output voltage. The power circuitry is preferably implemented within the battery housing, although the power circuitry may be provided whole, or in part, external from the battery housing.

Thus, a battery housing consistent with the present disclosure allows for user/operator selection between two different battery types. In one particular scenario, a battery housing consistent with the present disclosure is particularly well suited for use in battery operated devices deployed for field operations such as hand-held radios and smart phones. Such devices may be operated in a range of environmental conditions that no one single type of battery, e.g., due to battery chemistry, cost and/or availability, is ideal for operation of the device.

Further, a battery housing consistent with the present disclosure advantageously includes an overall footprint that is reduced or otherwise minimized based on a common battery cradle consistent with the present disclosure. The battery housing can also preferably output a constant nominal voltage (also referred to herein as a constant voltage) regardless of the selected battery type, and more preferably, can be utilized in existing battery-operated equipment without alteration to the circuitry of the equipment. Simply put, the battery housing may be configured to output a standard voltage, e.g., 9V, or other desired voltage to avoid the necessity of modifying the host device and/or battery housing. Thus, a device implementing a battery housing consistent with the present disclosure can operate with different types of batteries without necessarily increasing component count, e.g., DC step-down/up converter arrangements, and without necessarily increasingly overall battery housing size by dedicating space for the different battery types. It should be further noted that a battery housing consistent with the present disclosure may also be utilized by a battery recharging device.

Various examples and scenarios disclosed herein refer to first and second battery types, and the first and second battery types being different from each other. In this context, differences between first and second battery types means, for instance, a difference in at least one of a battery dimension (e.g., geometry of the battery package), battery chemistry, and/or nominal electrical characteristics. For example, a first battery implemented as an AA-type battery includes a different battery geometry and nominal electrical characteristics relative to a second battery type implemented as a 9V-type battery. Further, while specific reference is made herein to standard-type batteries such as AA-type batteries, CR123 batteries, and 9V batteries, this disclosure is not limited in this regard. The present disclosure contemplates non-standard battery types such as custom batteries with custom package geometries, chemistries and/or electrical characteristics. A battery housing consistent with the present disclosure may therefore utilize standard type batteries, non-standard type batteries, or a mix of both.

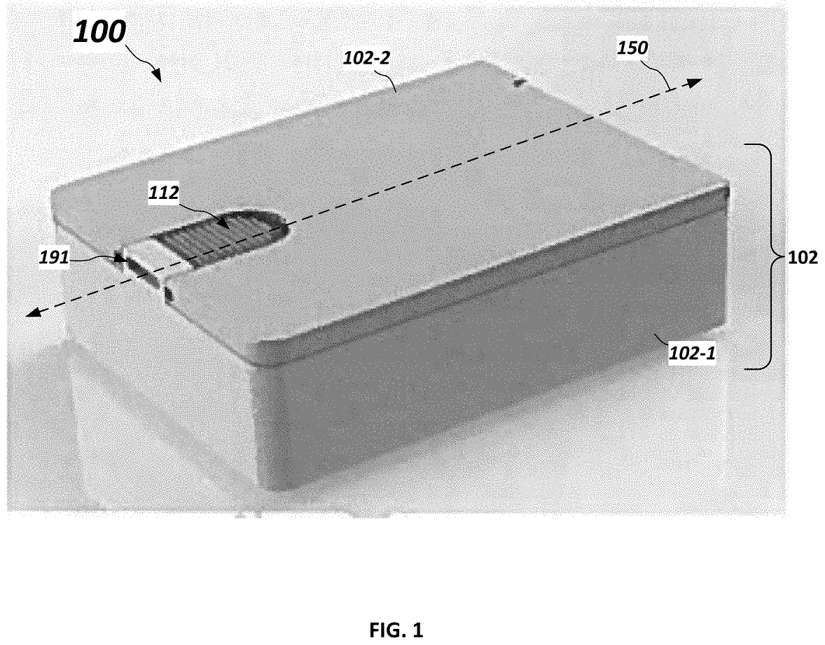

Turning to the figures, FIG. 1 shows an example battery housing 100 consistent with aspects of the present disclosure. The battery housing 100 preferably includes a plurality of housing portions shown collectively at 102 and individually as first and second housing portions 102-1 and 102-2, which are configured to couple together. The first housing portion 102-1 may also be referred to as a base portion or simply a base, and the second housing portion 102-2 may also be referred to herein as a cover. The second housing portion 102-2 preferably is configured to removably couple to the first housing portion 102-1. The second housing portion 102-2 can optionally include a locking member 112 for securely coupling the first and second housing portions 102-1, 102-2 to each other. The battery housing 100 further preferably includes an electrical coupling receptacle 191 disposed at an end for electrically coupling to an external load/circuitry. Preferably, the first housing portion 102-1 defines a cavity for holding batteries of two different types, as is discussed in detail further below. The first housing portion 102-1 preferably defines an opening in communication with the cavity to allow for insertion of batteries into the cavity.

The battery housing 100 preferably includes a plurality of sidewalls that extend along longitudinal axis 150. The example battery housing 100 includes a rectangular shape/profile, although other shapes are within the scope of this disclosure. The example battery housing 100 can comprise a plastic such as, for example, nylon, acrylonitrile butadiene styrene (ABS), polyvinyl chloride (PVC), polycarbonate, or other materials such as insulated metal.

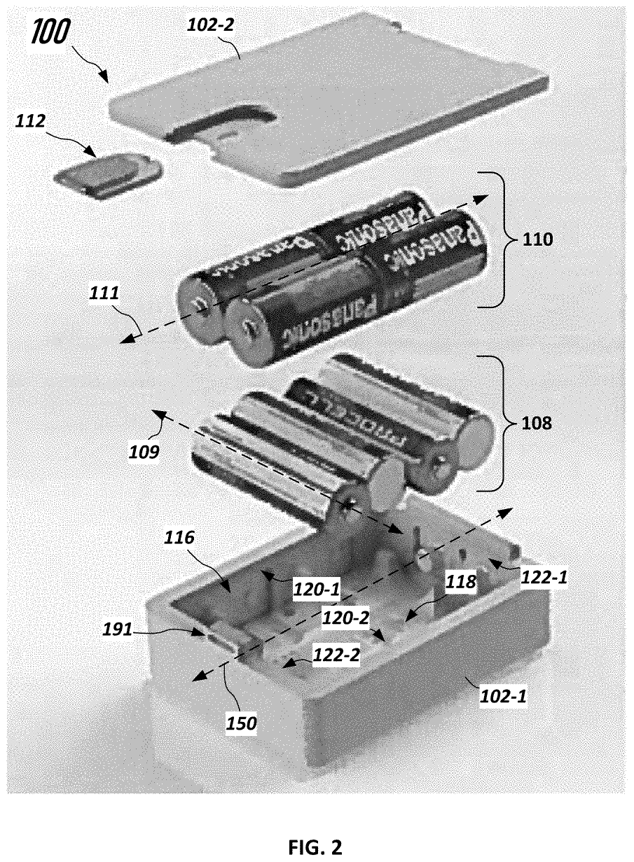

FIG. 2 shows the battery housing 100 of FIG. 2 partially exploded in accordance with aspects of the present disclosure. As shown, the first housing portion 102-1 defines a cavity 116. The first housing portion 102-1 further defines a common battery cradle 118 defined by a base surface within the cavity 116. The common battery cradle 118 is preferably formed with the first housing portion 102-1 as a single, monolithic piece. However, the common battery cradle 118 and the first housing portion 102-1 may be formed as multiple separate pieces of the same or different material. The common battery cradle 118 preferably defines at least one battery slot/groove for supporting/holding a battery of a first type and at least one battery slot/groove for holding a battery of a second type, as is discussed further below. The at least one battery groove/slot preferably underlies and supports a battery disposed thereon.

The cavity 116 further includes a plurality of battery terminals preferably implemented as temporary electrical interconnects such as battery spring contacts. In the example of FIG. 2, the cavity 116 is preferably defined at least in part by first and second longitudinal sidewalls 120-1, 120-2 that extend at an angle of 90±5 degrees from the base surface of the common battery cradle 118, which may also be referred to herein as extending in a transverse relationship.

The cavity 116 is further preferably defined at least in part by first and second lateral sidewalls 122-1, 122-2 that also preferably extend from the common battery cradle 118 in a transverse relationship. More preferably, the first and second lateral sidewalls 122-1, 122-2 adjoin the first and second longitudinal sidewalls 120-1, 120-2 such that the cavity 116 is fully enclosed/encircled. Accordingly, the cavity 116 may then be sealed for purposes of minimizing or otherwise reducing the ingress of contaminants within the cavity 116 such as dust. In one preferred example, the battery housing 100 includes an ingress protecting (IP) rating that comports with IP60 as defined in international standard IEC 60529.

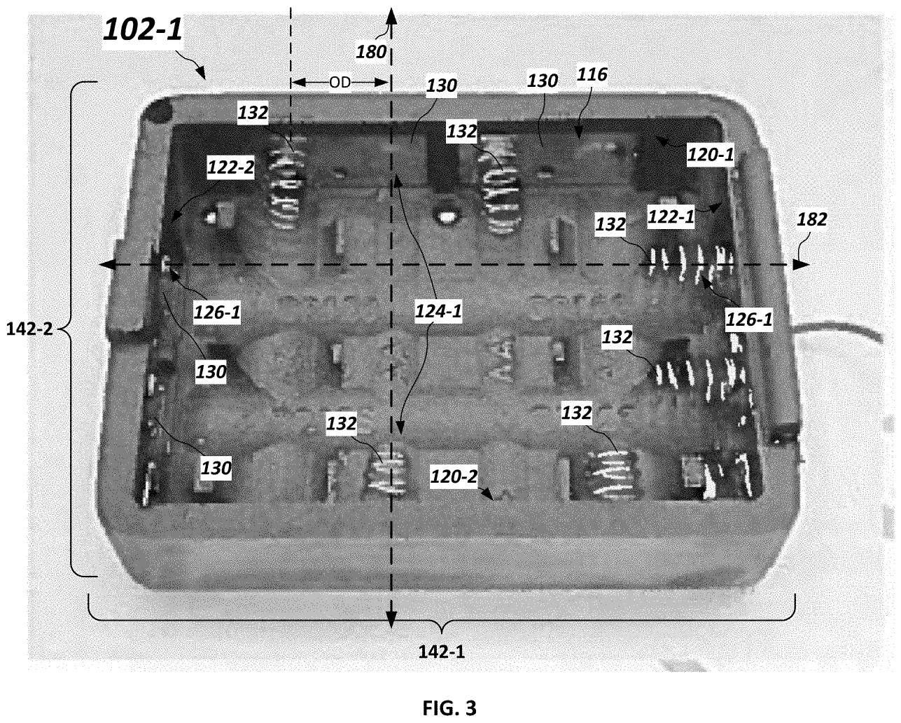

FIG. 3, with additional reference to FIG. 2, shows an example of the first housing portion 102-1 in isolation. The cavity 116 preferably includes a first plurality of battery terminal pairs 142-1 to couple to batteries of a first battery type and a second plurality of battery terminal pairs 142-2 to couple to batteries of a second battery type.

In the preferred example of FIG. 3, the first and second plurality of battery terminal pairs 142-1, 142-2 are implemented via a plurality of spring contacts 132 and a plurality of fixed contacts 130. The spring contacts 132 may also be referred to herein as spring-biased negative terminals or simply negative terminals. Likewise, the fixed contacts 130 may also be referred to herein as flat positive terminals, or simply positive terminals. Each battery terminal pair includes a spring contact of the plurality of spring contacts 132 disposed opposite a corresponding fixed contact of the plurality of fixed contacts 130 within the cavity 116.

As shown, the first and second longitudinal sidewalls 120-1, 120-2 preferably provide the first plurality of battery terminal pairs 142-1. For instance, a first battery terminal pair 124-1 is disposed on the first and second longitudinal sidewalls 120-1, 120-2 and includes a flat contact (or fixed contact) of the plurality of flat contacts 130 disposed on the first longitudinal sidewall 120-1 and a spring contact of the plurality of spring contacts 132 disposed on the second longitudinal sidewall 120-2. Thus, an imaginary line 180 drawn transverse relative to the longitudinal axis 150 (See FIG. 2) of the battery housing 100 intersects with the fixed contact and the spring contact of the first battery terminal pair 124-1.

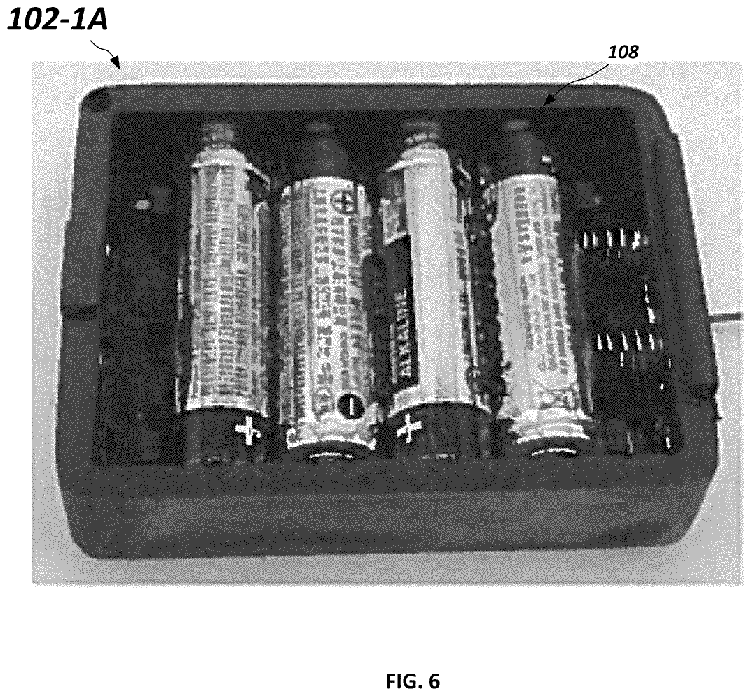

Each of the first plurality of battery terminal pairs 142-1 are preferably disposed at a predetermined offset distance relative to each other, with the predetermined offset distance between each adjacent battery terminal pair of the first plurality of battery terminal pairs 142-1 being determined based on the first battery type. For instance, the first type of battery may be AA-type batteries 108 (FIG. 2) which include a diameter in the range of 13.5-14.5 mm. Thus, the center-to-center distance OD between each adjacent battery terminal pair along the first and second longitudinal sidewalls may be in the range of 6.75 mm to 7.25 mm to accommodate the AA-type batteries 108 being disposed in a side-by-side manner (See e.g., FIG. 6), with each battery extending substantially parallel with adjacent batteries. More preferably, the first plurality of battery pair terminals is configured to couple the first type of batteries electrically in series with each other.

Likewise, each battery terminal pair includes a spring contact disposed at a predetermined distance across the cavity 116 from a corresponding fixed contact. In the prior example of the first battery type being AA batteries, the predetermined distance can be in the range of 49.2-50.5 mm, or less, to ensure that a battery disposed therebetween displaces the spring contact and gets held in place based in part on the bias force supplied by the spring contact.

Preferably, each of the first type of batteries, e.g., the AA-type batteries 108, include a longitudinal axis 109 (FIG. 2) that extends substantially transverse relative to the longitudinal axis 150 of the battery housing 100 when disposed within the cavity 116 and electrically couple to a pair of battery terminals of the first plurality of battery terminal pairs 142-1.

As further shown, the first and second lateral sidewalls 122-1, 122-2 provide the second plurality of battery terminal pairs 142-2. Each battery terminal pair of the second plurality of battery terminal pairs 142-2 also preferably include a spring contact of the plurality of spring contacts 132 and a corresponding fixed contact of the plurality of fixed contacts 130. For example, a second battery terminal pair 126-1 includes a spring contact disposed opposite a fixed contact such that a second imaginary line 182 that extends substantially parallel with the longitudinal axis 150 of the battery housing 102 intersects with each. Thus, the first imaginary line 180 drawn through the first battery terminal pair 124-1 along a first axis extends substantially transverse relative to the longitudinal axis 150 of the battery housing 102 (See FIG. 2), and the second imaginary line 182 drawn through the second battery terminal pair 126-1 along a second axis extends substantially parallel with the longitudinal axis 150.

Each battery terminal pair of the second plurality of battery terminal pairs 142-2 is also preferably disposed at a predetermined offset distance from each other, with the predetermined offset distance being determined based on a second battery type. For instance, the second type of battery may be CR123A-type batteries 110 (FIG. 2) which include a diameter of 17 mm. Thus, the center-to-center distance OD between each adjacent battery terminal pair along the first and second lateral sidewalls 122-1, 122-2 may be 17 mm to accommodate the CR123A-type batteries 110 being disposed in a side-by-side manner, for example. Likewise, each battery terminal pair of the second plurality of battery terminal pairs 142-1 preferably include a spring contact disposed at a predetermined distance across the cavity 116 from a corresponding fixed contact. The predetermined distance is preferably twice the length of the second type of battery to allow for two or more batteries of the second type to extend between each battery terminal pair of the second plurality of battery terminal pairs 142-2. In the prior example of the second battery type being CR123A batteries with a 34.5 mm overall length, the predetermined distance is preferably at least 69±2 mm to ensure that batteries disposed therebetween displace the spring contact and gets held in place based in part on the bias force supplied by the spring contact.

Preferably, each of the second type of batteries, e.g., the CR123A-type batteries 110, include a longitudinal axis 111 (FIG. 2) that extends substantially parallel relative to the longitudinal axis 150 of the battery housing 100 when disposed within the cavity 116 and electrically coupled to a pair of battery terminals of the second plurality of battery terminal pairs 142-2.

As shown in the example of FIG. 4, the first type of batteries implemented as cut/sliced AA-type batteries 108′ are disposed within the cavity 116 along with the second type of batteries implemented as CR123A-type batteries 110. This arrangement shown in FIG. 4 is physically impossible without cutting/modifying batteries and is designed to demonstrate that the cavity 116 of the battery housing is configured to hold batteries of the first type or the second type within a common/shared horizontal plane 190. More preferably, the common horizontal plane 190 extends longitudinally through/intersects with each of the first and second plurality of battery terminal pairs 142-1, 142-2, and thus by extension, each battery of the first type or the second type from end to end depending on which battery type is disposed in the housing. Thus, insertion of the first type of battery, e.g., AA-type batteries 108, prevent insertion of the second type of battery, e.g., CR123A-type batteries 110, and vice-versa, based on the common horizontal plane 190. However, this common horizontal plane 190 also ensures that the overall footprint of the battery housing is reduced or otherwise minimized while still allowing for two different battery types to be stored therein.

FIG. 5 shows a top-down view of an example of the first housing portion 102-1 in accordance with aspects of the present disclosure. As shown, the common battery cradle 118 defines at least one battery groove/slot that extends between the first and second longitudinal sidewalls 120-1, 120-2 to couple to and support a battery of the first type, and at least one battery groove/slot that extends between the first and second lateral sidewalls 122-1, 122-2 to couple to and support a battery of the second type. Preferably, and as shown, the common battery cradle 118 defines a first plurality of battery grooves shown collectively as 160 and individually as battery grooves 160-1, 160-2, 160-3, and 160-4. Likewise, the common battery cradle 118 defines a second plurality of battery grooves shown collectively as 162 and individually as battery grooves 162-1 to 162-2. The battery grooves may also be referred to herein as grooves.

The first and second plurality of battery grooves 160, 162 are further preferably defined by a convex/concave surface of the common battery cradle 118. The dimensions of the first plurality of grooves 160 preferably correspond with the dimensions of a battery package of the first battery type such that batteries of the first type may be at least partially received therein and held in alignment between contacts of an associated battery terminal pair. Likewise, the dimensions of the second plurality of battery grooves 162 preferably correspond with the dimensions of a battery package of the second battery type such that batteries of the second type may be at least partially received therein and held in alignment between contacts of an associated battery terminal pair.

Thus, the first plurality of battery grooves 160 preferably include a profile that corresponds to the package profile of the first type of battery, and the second plurality of grooves 162 includes a profile that corresponds to the package profile of the second type of battery, with the package profile of the first type of battery being different than the package profile of the second battery type (e.g., the first and second battery types include a package profile with at least one different dimension such as length, width and/or height). In one example, the package profile of the first battery type (e.g., AA-type batteries 108) includes a cylindrical shape (e.g., see FIGS. 2 and 3) and the first plurality of battery grooves 160 include a cylindrical profile to allow for at least a portion of a battery of the first battery type to extend therein and electrically couple to associated battery terminals, e.g., the first plurality of battery terminal pairs 142-1 shown in FIG. 3. Likewise, the package profile of the second battery type (e.g., CR123A batteries 110) can include a cylindrical shape, such as shown in FIG. 2, and the second plurality of grooves 162 can include a cylindrical profile to allow for at least a portion of a battery of the second battery type to extend therein and electrically couple to associated battery terminals, e.g., the second plurality of battery terminals pairs 142-2 shown in FIG. 3. However, it should be appreciated that other groove profiles/shapes are within the scope of this disclosure to support coupling to other battery package types such as 9V batteries which include a rectangular package profile.

As shown in FIG. 5, each of the second plurality of battery grooves 162 preferably extend across each of the first plurality of battery grooves 160. Stated differently, each of the second plurality of battery grooves 162 preferably intersect with each of the first plurality of battery grooves 160. As discussed above, this causes the common battery cradle 118 to mount/support batteries of the first or second type in the common horizontal plane 190.

Each battery groove of the first and second battery grooves 160, 162 preferably include a visual indicator to simplify battery insertion by a user/operator. For example, the first battery groove 160-1 includes a first indicator, such as indicator 168-1, that allows a user/operator to identify a compatible battery type, e.g., “AA” as shown, and/or a polarity indicator to allow for the user/operator to identify a proper orientation. Likewise, the second battery grooves 162 can include a second visual indicator, such as indicator 168-2, to aid a user during insertion of the second battery type.

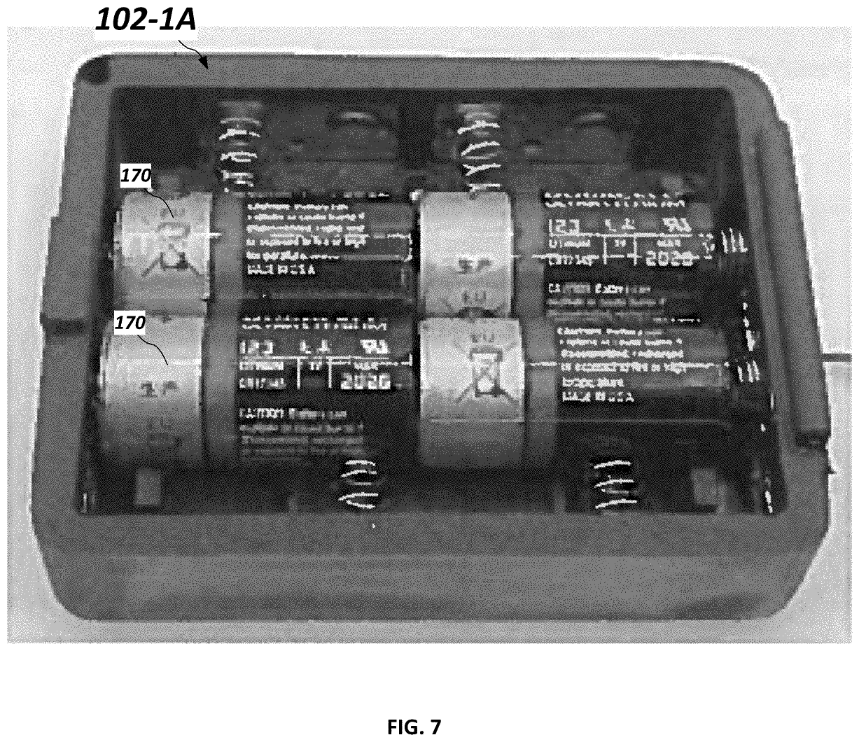

Note, a battery housing consistent with the present disclosure is not necessarily limited to AA and CR123A batteries, and a battery housing consistent with the present disclosure can be configured to hold a wide variety of battery type combinations. For example, in FIG. 6 the cavity 116 of the first housing portion 102-1A can be configured to electrically couple to batteries of a first type implemented as AA-type batteries 108, or alternatively, can be configured to electrically couple to batteries of a second type implemented as CR123-type batteries 170 as shown in FIG. 7.

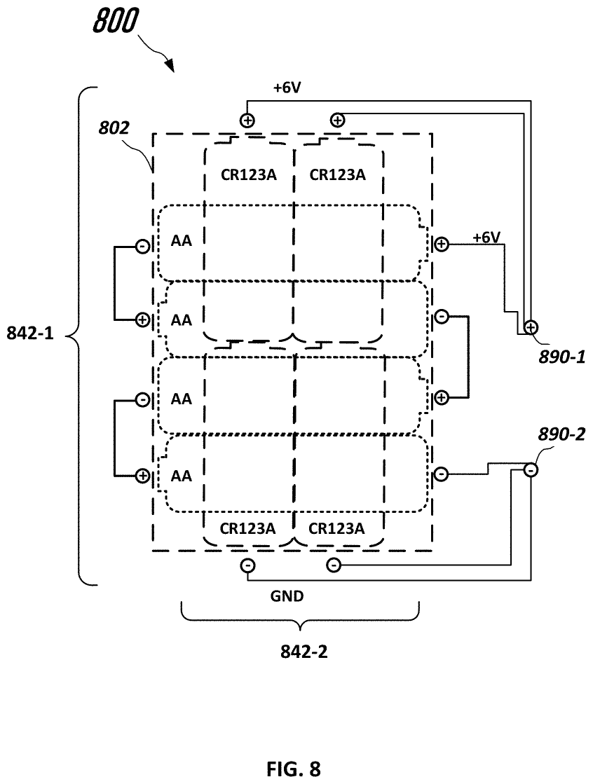

FIG. 8 shows an example schematic 800 of a battery housing 802 consistent with the present disclosure. The battery housing 802 may be configured as the battery housing 100 of FIGS. 1-5, the description of which will not be repeated for brevity. As shown, the first plurality of battery terminal pairs 842-1 electrically couple to a plurality of batteries of a first battery type, and the second plurality of battery terminal pairs 842-2 electrically couple to a plurality of batteries of a second battery type, the second battery type being different than the first battery type.

In the preferred example of FIG. 8, this includes the plurality of batteries of the first type being implemented as AA-type batteries and the second plurality of batteries of the second type being implemented as CR123A-batteries. The first plurality of battery terminal pairs 842-1 is preferably configured to electrically couple each of the AA-type batteries electrically in series with each other, and with a positive output terminal 890-1 and a negative output terminal 890-2. In this configuration, each AA battery provides a nominal 1.5V and collectively provide 6V potential between the positive and negative output terminals 890-1, 890-2. In addition, the second plurality of battery terminal pairs 842-2 is preferably configured to electrically couple batteries of the second type in parallel with each other. In the context of the example of FIG. 8, this includes two pairs of CR123A batteries coupled electrically in series to provide a summed voltage of 6V. The two pairs of CR123A batteries are then coupled in parallel with each other via the output positive and negative terminals 890-1, 890-2.

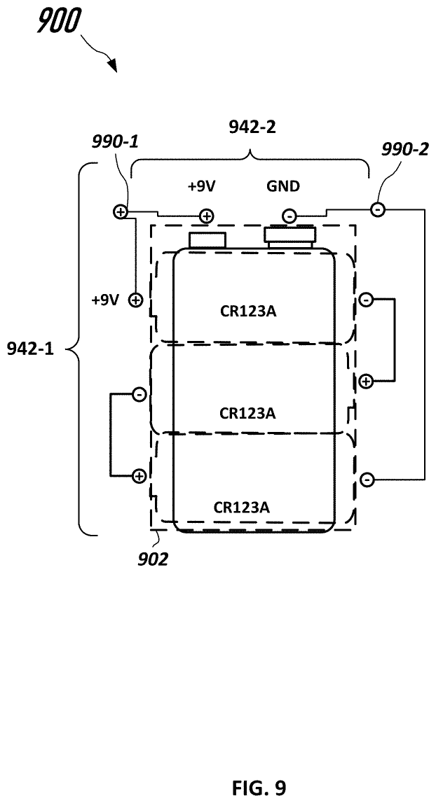

FIG. 9 shows another example schematic 900 of a battery housing 902 consistent with the present disclosure. The battery housing 902 may be configured substantially similar to that of battery housing 100 of FIGS. 1-5, the description of which will not be repeated for brevity. However, and as shown, the first plurality of battery terminal pairs 942-1 electrically couple to a plurality of batteries of a first battery type implemented as CR123A-type batteries, and the second plurality of battery terminal pairs 942-2 electrically couple to a battery of a second type implemented as a 9V-type battery. In this configuration, the first plurality of battery terminal pairs 942-1 electrically couple the CR123A-type batteries in series to provide a nominal output voltage of 9V. Thus, the output voltage potential between the output positive and negative terminals 990-1, 990-2 is 9V in this preferred example regardless of whether CR123A batteries or a 9V battery is electrically coupled within the battery housing 902. Notably, in this example the output voltage of the battery housing 902 is therefore equal to at least the output voltage of the 9V battery, e.g., 9 volts.

In accordance with an aspect of the present disclosure a battery housing is disclosed. The battery housing comprising a base portion defining a cavity, a first battery terminal pair disposed in the cavity, the first battery terminal pair including first and second battery terminals disposed opposite each other within the cavity for coupling to a first type of battery, a second battery terminal pair disposed in the cavity, the second battery terminal pair including first and second battery terminals disposed opposite each other within the cavity for coupling to a second type of battery, the second type of battery being different than the first type of battery, and wherein a common horizontal plane intersects with the first and second battery terminal pairs.

In accordance with another aspect of the present disclosure a battery housing is disclosed. The battery housing comprising a base portion defining a cavity, a common battery cradle disposed in the cavity, the common battery cradle having at least a first battery groove to couple to a battery of a first type and at least a second battery groove to couple to a battery of the second type, wherein the first and second battery grooves intersect with each other, a first plurality of battery terminals disposed in the cavity to electrically couple to at least one battery of the first type, and a second plurality of battery terminals disposed in the cavity to electrically couple to at least one battery of the second type.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. It will be appreciated by a person skilled in the art that an apparatus may embody any one or more of the features contained herein and that the features may be used in any particular combination or sub-combination. Modifications and substitutions by one of ordinary skill in the art are considered to be within the scope of the present disclosure, which is not to be limited except by the claims.

What is claimed is:

1. A battery housing comprising:
a base portion defining a cavity;
a first battery terminal pair disposed in the cavity, the first battery terminal pair including first and second battery terminals disposed opposite each other within the cavity for coupling to a first type of battery;
a second battery terminal pair disposed in the cavity, the second battery terminal pair including first and second battery terminals disposed opposite each other within the cavity for coupling to a second type of battery, the second type of battery being different than the first type of battery; and
wherein a common horizontal plane intersects with the first and second battery terminal pairs.

2. The battery housing of claim 1, wherein the cavity extends from a first end to a second end along a longitudinal axis of the base portion, and wherein a first imaginary line drawn through the first battery terminal pair along a first axis extends substantially transverse relative to the longitudinal axis, and a second imaginary line drawn through the second battery terminal pair along a second axis extends substantially parallel with the longitudinal axis.

3. The battery housing of claim 1, wherein the base defines a common battery cradle within the cavity that extends between the first battery terminal pair and the second battery terminal pair.

4. The battery housing of claim 3, wherein the common battery cradle includes a first groove that extends between the first battery terminal pair to couple to a battery of the first type of battery, and a second groove that extends between the second battery terminal pair to couple to a battery of the second type of battery, and wherein the first groove intersects with the second groove such that a battery of the first battery type disposed in the first groove extends across the second groove.

5. The battery housing of claim 4, wherein the first groove includes a profile that corresponds to a package profile of the first type of battery, and the second groove includes a profile that corresponds to a package profile of the second type of battery, the package profile of the first type of battery being different than the package profile of the second battery type.

6. The battery housing of claim 5, wherein the package profile of the first battery type includes a cylindrical shape, and the first groove includes a cylindrical profile to allow for at least a portion of a battery of the first battery type to extend into the first groove and electrically couple to the first battery terminal pair, and wherein the package profile of the second battery type includes a cylindrical shape, and the second groove includes a cylindrical profile to allow for at least a portion of a battery of the second battery type to extend into the second groove to electrically couple to the second battery terminal pair.

7. The battery housing of claim 3, further comprising a first battery of the first battery type disposed on the common battery cradle in the cavity of the base and electrically coupled to the first battery terminal pair, and wherein the first battery prevents coupling of a second battery of the second battery type to the common battery cradle in the cavity.

8. The battery housing of claim 3, wherein the base defines an opening in communication with the cavity, and wherein the opening is configured to allow insertion of either batteries of the first battery type or the second battery type.

9. The battery housing of claim 1, wherein the first type of battery includes an output voltage that is less than the output voltage of the second type of battery, and wherein the battery housing is configured to output a constant voltage equal to at least the output voltage of the second type of battery.

10. The battery housing of claim 1, wherein the first battery terminal of the first battery terminal pair is implemented as a spring contact and the second battery terminal of the first battery terminal pair is implemented as a fixed contact.

11. The battery housing of claim 1, wherein the first and second battery terminals of the first battery terminal pair are implemented as positive and negative battery terminals, respectively, and wherein the first and second battery terminals of the first battery terminal pair are disposed at a predetermined distance from each other within the cavity based on the first type of battery.

12. The battery housing of claim 11, wherein the first and second battery terminals of the second battery terminal pair are implemented as positive and negative battery terminals, respectively, and wherein the first and second battery terminals of the second battery terminal pair are disposed at a predetermined distance from each other within the cavity based on the second type of battery.

13. A battery housing, the battery housing comprising:
a base portion defining a cavity;
a common battery cradle disposed in the cavity, the common battery cradle having at least a first battery groove to couple to a battery of a first type and at least a second battery groove to couple to a battery of the second type, wherein the first and second battery grooves intersect with each other;
a first plurality of battery terminals disposed in the cavity to electrically couple to at least one battery of the first type; and
a second plurality of battery terminals disposed in the cavity to electrically couple to at least one battery of the second type.

14. The battery housing of claim 13, wherein the common battery cradle comprises a first plurality of battery grooves that includes the first battery groove to couple to a plurality of batteries of the first type.

15. The battery housing of claim 14, wherein the first plurality of grooves are configured to couple to the plurality of batteries of the first type and electrically couple the plurality of batteries to each other in series based on the first plurality of battery terminals.

16. The battery housing of claim 13, wherein the common battery cradle comprises a second plurality of battery grooves that includes the second battery groove to couple to a plurality of batteries of the second type.

17. The battery housing of claim 16, wherein each battery groove of the second plurality of battery grooves is configured to couple to at least two batteries of the second type of battery.

18. The battery housing of claim 13, wherein the common battery cradle includes at least a first visual indicator corresponding to the battery of the first type.

19. The battery housing of claim 13, wherein the common battery housing is configured to output a constant voltage.

20. The battery housing of claim 13, wherein the battery housing includes first and second longitudinal sidewalls that extend along a longitudinal axis of the battery housing, and first and second lateral sidewalls that extend substantially transverse relative to the longitudinal axis of the battery housing, and wherein the first plurality of battery terminals are disposed on the first and second longitudinal sidewalls, and the second plurality of battery terminals are disposed on the first and second lateral sidewalls.
